(19) United States
(12) Patent Application Publication
(10) Pub. No.: US 2008/0072625 A1
(43) Pub. Date: Mar. 27, 2008

(54) Method and Apparatus for Heating Sheets of Glass

(75) Inventors: Jukka Vehmas, Tampere (FI); Olli Jarvinen, Ylojarvi (FI)

Correspondence Address: BUCHANAN, INGERSOLL & ROONEY PC, POST OFFICE BOX 1404, ALEXANDRIA, VA, 22313-1404, US

(73) Assignee: Uniglass Engineering Oy, Ylojarvi (FI)

(21) Appl. No.: 11/662,060

(22) PCT Filed: Sep. 6, 2005
(86) PCT No.: PCT/FI05/50309

§ 371 Date: Mar. 7, 2007

(30) Foreign Application Priority Data
Sep. 7, 2004 (FI) 20045328

(51) Int. Cl. C03B 29/08; C03B 27/012; C03B 35/16

(52) U.S. Cl. 65/114; 65/163

(57) ABSTRACT

Sheets of glass (3) are heated in a tempering furnace. The furnace comprises rollers (2) to carry and transfer the glass sheets (3). During the heating, the glass sheets (3) are oscillated, i.e. they are moved back and forth, by means of the rollers (2). The rollers (2) are controlled by a control device (6). The control device (6) is used for configuring a first turning point of oscillation (t₁) to take place more than 20 seconds after a starting time of heating (t₀).

### BACKGROUND OF THE INVENTION

The invention relates to a method of heating sheets of glass, the method comprising heating glass sheets in a tempering furnace and oscillating the glass sheets back and forth during the heating.

The invention further relates to an apparatus for heating sheets of glass, the apparatus comprising a tempering furnace for heating glass sheets, rollers for carrying and transferring the glass sheets, heating means for heating the glass sheets, and a control device for controlling the rollers, the control device being configured to control the rollers so as to oscillate the glass sheets during the heating.

### BRIEF DESCRIPTION OF THE INVENTION

In a glass tempering process, the temperature of a sheet of glass is raised above the softening point of glass. This point is 610 to 625° C., depending on the thickness of the glass. The glass is then cooled down at a desired speed, typically by blowing air jets at the glass both from above and below.

It is in practice impossible for a glass sheet, while being heated, to stay immobile in a furnace; if this were the case, the heating would be all too uneven due to the contact made by support points provided for the glass sheets. On the other hand, when the heating process were continued, the glass would begin to soften when the temperature of the glass exceeds 550° C., in which case the glass would start to yield between the support points so that the glass would be subjected to undulation. Therefore, glass sheets are thus kept in motion during heating.

A glass tempering furnace may be a so-called continuous furnace, in which case the glass is only moved forward during the entire heating process. Such a solution is efficient if a high capasity is desired, and the solution is appropriate for processing thin sheets of glass. In practice, however, such continuous furnaces are not suitable for heating thick sheets of glass because thick sheets of glass require a long heating period, and if the glass is only moved forward during the entire heating process, the furnace would have to be made unreasonably long. On the other hand, continuous furnaces are rather inflexible when glass types and thicknesses change. Different glass types and different glass thicknesses require different furnace temperatures and different transfer speeds, so a continuous furnace must always be emptied when the type of glass changes. This causes quite a long and disadvantageous period of unproductive operation.

In a so-called oscillating roller furnace, glass sheets are moved back and forth, i.e. oscillated, by means of rollers while the glass sheets are being heated. Such oscillation enables the support points for the rollers to be distributed evenly over the entire glass throughout the entire heating stage. This enables deformation faults in the optics of the glass due to uneven support to be minimized. Consequently, the oscillating furnace does not have to be made unreasonably long because the glass moves back and forth in the furnace. Furthermore, a switch-over from one glass type and glass thickness to another can be made relatively smoothly. Therefore, nowadays mainly oscillating roller furnaces are used when manufacturing e.g. planar building or insulation glasses. An example of an oscillating roller furnace is set forth in U.S. Pat. No. 6,172,336.

During heating, the glass sheets are mechanically touched by rollers only. Thus, in practice any possible scratches and other possible faults in the glass are caused by the rollers. The requirements for roller quality and roller rotation mechanisms are thus extremely strict. The diameter of the rollers is to remain as unchanged as possible, and the radius of the rollers is also to remain the same at an extremely high accuracy. Further, a roller drive should have as little clearance or backlash as possible and be as inflexible as possible. For example, a difference in the circumferential velocity of two rollers that simultaneously support the glass may cause a scratch in the glass sheet. The meachanical requirements for the structure of the furnace are thus extremely high, and as the parts wear down, it becomes even more difficult to be able to avoid faults in the optics of the glass.

An object of the present invention is to provide a novel method and apparatus for heating sheets of glass.

The method of the invention is characterized in that a first turning point of oscillation is configured to take place more than 20 seconds after a starting time of heating.

Furthermore, the apparatus of the invention is characterized in that the control device is configured to control the rollers such that a first turning point of oscillation is configured to take place more than 20 seconds after a starting time of heating.

According to the invention, glass sheets are heated in a furnace by oscillating them, i.e. moving them back and forth, during heating by means of rollers. A first turning point of oscillation is configured to take place more than 20 seconds after a starting time of heating. At an initial stage of the heating, the glass is quite unstable, which is why scratches and other marks easily occur thereon. When the first turning point of oscillation is configured to take place reasonably late after the starting time of heating, the glass can be heated up to a level of softness that enables the glass to lie against rollers in an even manner. In such a case, occurrence of marks on the glass sheet at the turning point of oscillation is quite unlikely even if the rollers had some clearance.

The idea underlying an embodiment is that a transfer travel from a loading conveyor to a furnace is carried out at a first speed, and when a load in its entirety resides inside the furnace, the speed is dropped to a second speed which is lower than the first one, and the first turning of oscillation takes place by slowing down from this second speed. The process of slowing down the speed to the second, lower speed is quite a simple and easily controlled control procedure which enables the first turning of oscillation to be configured to take place after rather a long time since the starting time of heating.

The idea underlying another embodiment is that a last turning point of oscillation is configured to take place more than 20 seconds before a termination time of heating. At a final stage of the heating, the glass is quite soft, which is also why faults easily occur thereon. Such faults may include e.g. hot spots and undulation of the glass. When the last turning of oscillation takes place before rather a long time since the termination time of heating, the glass is not too soft and, consequently, faults can mainly be prevented from occurring on the glass. The idea of still another embodiment is that the heating is configured to take place such that only two turning points of oscillation are provided, so that the first turning point of oscillation takes place after rather a long time since the starting time of heating and the last turning point of oscillation takes place before rather a long time since the termination time of heating, so as a whole it becomes possible to minimize the occurrence of faults on the glass.

### BRIEF DESCRIPTION OF THE DRAWINGS

The invention is described in closer detail in the accompanying drawings, in which

FIG. 1 is a schematic, sectional side view showing a glass tempering furnace, and

FIG. 2 is a diagram showing how glass moves inside a furnace during a heating period.

For the sake of clarity, the figures show the invention in a simplified manner. Like reference numerals identify like elements.

### DETAILED DESCRIPTION OF THE INVENTION

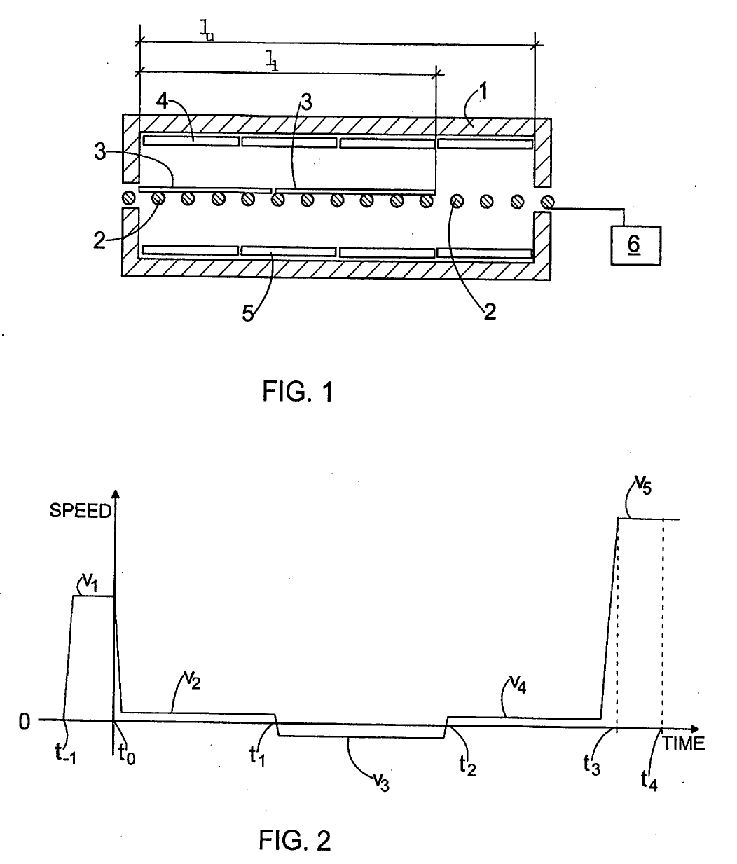

FIG. 1 shows a tempering furnace comprising a body 1 and rollers 2 onto which glass sheets 3 are arranged. The glass sheets are heated from above by upper resistors 4 and from below by lower resistors 5. The furnace may further include blowpipes to enable upper surface and/or lower surface of the glass sheets to be heated by blowing warm air thereagainst, i.e. forced convention to be used. When necessary, the pipes may also be used for cooling. For the sake of clarity, the accompanying figures show no such pipes.

Furthermore, FIG. 1 schematically shows a control device 6, which at the same time describes a power device, such as an electric motor, to be used for rotating the rollers 2, and also a control device for controlling the rotation of the rollers. The electric motor rotating the rollers can be controlled e.g. by an inverter. Further, when desired, gear systems and/or other suitable means can be used for controlling the rollers 2.

In the apparatus, the tempering furnace is preceded by a loading conveyor. After the tempering furnace, in turn, a tempering unit is provided in which the glass sheets are cooled down by blowing cooling air at them. After the tempering unit there may also be provided an aftercooling unit. For the sake of clarity, FIG. 1 shows no loading conveyor, tempering unit nor aftercooling unit.

During heating, the glass sheets 3 are moved back and forth, i.e. oscillated, by means of the rollers 2. The oscillation enables support points for the rollers 2 to be distributed evenly over the entire glass throughout the entire heating stage.

A glass load is first started to be transferred from the loading conveyor to the furnace at a time t₋₁ shown in FIG. 2. After acceleration, a transfer speed v₁ may be e.g. 300 mm/s. At a time t₀, the glass load in its entirety resides within the furnace. In connection with the present description, the starting time of heating refers exactly to this particular time t₀, when the rear part of the glass load also resides in the furnace. FIG. 1 describes a situation in which the glass sheets 3 reside at the starting time of heating.

When the glass load in its entirety resides in the furnace, a transfer travel speed is dropped to a first crawling speed v₂. This first crawling speed v₂ may be e.g. 20 mm/s. The transfer travel into the furnace thus takes place between the times t₋₁ and t₁, and the particular transfer travel thus first takes place at the higher speed v₁ and, subsequently, at the lower speed v₂. The speed v₁, i.e. the speed at which the glass load is transferred into the furnace, should be considerably high because when the glass load is being transferred into the furnace, a front part of the load starts to heat up earlier than a rear part thereof, and at a low transfer speed a difference in temperature between the front and rear parts of the glass load would become too large such that the glass might be damaged. Furthermore, too low a transfer speed would cut the capacity of the furnace.

In order to enable oscillation to occur in the first place, the tempering furnace should be large enough so as to enable the glass load to move therein, i.e. the length lᵤ of the tempering furnace is to be larger than the length lₗ of the glass load part. If the length lᵤ of the tempering furnace is e.g. 4 800 mm, a suitable magnitude for the length lₗ of the glass load is e.g. 3 600 mm. In such a case, the glass load still has a distance of 1 200 mm within which to move in the furnace.

The process of slowing down from the transfer speed v₁ to the first crawling speed v₂ may take e.g. 1 to 3 seconds. If the process of slowing down takes place e.g. in slightly less than three seconds, the glass load has moved a distance of 450 mm forward after the time t₀, so that the glass load still has a distance of 750 mm within which to move. If the first crawling speed v₂ is 20 mm/s, it takes the glass load about 37.5 seconds to move toward a rear end of the furnace such that the front part of the glass load resides at the rear end of the furnace. No later than at this stage has a first turning of oscillation to be carried out. The turning of oscillation thus takes place at the time t₁ at which the speed is changed from the first crawling speed v₂ to a second crawling speed v₃. The second crawling speed v₃ may be e.g. −10 mm/s, wherein the negative sign thus means that the glass load moves back towards a front end of the furnace.

In the above-described exemplary case, the first turning point of oscillation t₁ takes place about 40 seconds after the starting time of heating. During these 40 seconds, the glass sheets 3, due to the influence of heating, have already become slightly softer, such that they lie evenly against the rollers 2. In such a case, in connection with the turning of oscillation, the rollers leave substantially no marks on the glass sheet 3.

If the second crawling speed v₃ is −10 mm/s, the next turning point of oscillation t₂ takes place no later than 120 seconds after the first turning point of oscillation t₁. At the second turning point of oscillation, the direction of movement of the glass load is again changed toward the rear end of the furnace, i.e. the speed is changed to a third crawling speed v₄. The third crawling speed v₄ may equal e.g. the first crawling speed v₂, i.e. in the exemplary case 20 mm/s.

Finally, the speed of the glass load is accelerated to an output transfer speed v₅, which may be e.g. 500 mm/s. The acceleration to the output transfer speed v₅ may take e.g. 1 to 4 seconds. At the output transfer speed v₅, the glass is driven out of the furnace to a tempering unit, and a next glass load is transferred into the furnace. The output transfer speed v₅ should be quite high because after the furnace the glass sheets 3 are subjected to tempering cooling, and the front part of the glass load is not to cool down too much as compared with the rear part of the glass load which exits the furnace later. Furthermore, a low output transfer speed would cut the capacity of the machine. In the exemplary case, the time span between the last turning point of oscillation t₂ and the termination time of heating t₃ is about 40 seconds. A transfer travel out of the furnace thus starts at the second turning point of oscillation t₂ and ends after the time t₄, which is the moment at which the glass load in its entirety resides outside the furnace. This transfer travel out of the furnace thus first takes place at the lower speed v₄ and, subsequently and finally, at the second speed v₅, which is higher than the first speed.

In conjunction with the present description, the termination time of heating t₃ refers to a point in time at which the front end of the glass load starts exiting the tempering furnace. The heating time shown in the example, i.e. the time span between the starting time of heating to and the termination time of heating t₃, about 200 seconds, will suffice as a heating time for thin glass, e.g. glass having a thickness of 2.5 mm.

The time of the last turning point of oscillation t₂ and the termination time of heating t₃ are thus spaced quite widely apart. In such a case, the glass sheets 3 at the last turning point of oscillation t₂ are still hard enough to substantially resist marks or other faults due to the turning of oscillation. Thus, the quality of the glass sheets remains extremely good during the entire tempering process.

The crawling speeds v₂, v₃ and v₄ may be e.g. 10 mm/s to 60 mm/s. The absolute values of the crawling speeds v₂, v₃ and v₄ may also be equal or the magnitude of each speed may be different. The transfer speed v₁ for transferring the glass sheets into the furnace may be e.g. 200 to 400 mm/s. The output transfer speed v₅, in turn, may be e.g. 400 to 600 mm/s.

By lowering the crawling speeds v₂, v₃ and v₄ from those of the above example, the heating time of one load can be increased while nevertheless employing only two turning points of oscillation. When only two turning points of oscillation are used, occurrence of faults on the glass sheets 3 can be minimized. Of course, the lowering of the second crawling speed v₃ refers to decreasing its absolute value, i.e. to the glass sheets moving backwards in the furnace at a lower speed. In practice, however, the crawling speed cannot be lowered too much either, so the arrangement according to the above example enables the glass to be heated by using only two turning points of oscillation in a case where the heating time of glass is less than 300 seconds. If the crawling speed is too low, the hot rollers 2 cause heat-balance-related problems to the glass. Similarly, at a final stage of heating, too low a crawling speed may cause undulation in the glass. If thicker glasses are heated in the furnace, one back-and-forth oscillation has to be added at certain intervals. An interval of incremental steps of the back-and-forth oscillations is preferably arranged at intervals of e.g. 300 seconds. In such a case, however, it is preferable to distribute the heating time evenly between both reciprocating oscillations to ensure that the furnace is loaded evenly.

The drawing and the related description are only intended to illustrate the idea of the invention. In its details the invention may vary within the scope of the claims. The crawling speeds are also affected by the extent of space provided for the glass load to move in the tempering furnace. If the space for movement is reasonably long, the crawling speed should in turn be slightly higher in order for the movement of the glass load to be distributed evenly within the furnace. The length of the space for movement is thus affected by the length of the furnace and the length of the glass load, in which case by determining the magnitude of the glass load it is possible to determine the magnitude of the space for movement. The space for movement should thus be sufficient in order to enable the first oscillation to be carried out sufficiently late after the starting time of heating. The space for movement should not, however, be too large, because a large space for movement, in turn, decreases the magnitude of the glass load, which means that the production capacity of the furnace drops. Furthermore, the crawling speed may preferably be configured on the basis of the glass load such that the load is at the front end of the furnace always at the same stage of heating, which makes the heating process as a whole simple to manage. If desired, the temperature of the glass can be measured during heating by means of e.g. a pyrometer and utilize the measurement to manage the heating. In addition to or instead of electric resistors and convection blowing, the glass sheets may be heated by means of a heating gas or another heating method known per se. The first turning point of oscillation is thus configured to take place more than 20 seconds after the starting time of heating. Preferably, the first turning point of oscillation is configured to take place more than 35 seconds after the starting time of heating. As a practical limitation, on the basis of the magnitude of the glass load and the magnitude of the crawling speed, the maximum time between the starting time of heating and the first turning point of oscillation may be of the order of 70 seconds. The last turning point of oscillation may thus be configured to take place e.g. more than 20 seconds before the termination time of heating. Preferably, the last turning point of oscillation is configured to take place more than 35 seconds before the termination time of heating. Also in this case, as a possible practical limitation it may occur that the last turning point of oscillation is not configured to take place more than 70 seconds before the termination point of heating.

1. A method of heating sheets of glass, the method comprising heating glass sheets in a tempering furnace and, during the heating, oscillating the glass sheets back and forth, wherein a first turning point of oscillation is configured to take place more than 20 seconds after a starting time of heating.

2. A method as claimed in claim 1, wherein the first turning point of oscillation is configured to take place more than 35 seconds after the starting time of heating.

3. A method as claimed in claim 1, wherein a transfer travel from a loading conveyor to the furnace is first carried out at a first speed and, when a load in its entirety resides in the furnace, the speed is dropped to a second speed which is a lower speed than the first speed, and a first turning of oscillation is carried out by slowing down from said second speed.

4. A method as claimed in claim 3, wherein a last turning point of oscillation is configured to take place more than 20 seconds before a termination time of heating.

5. A method as claimed in claim 4, wherein the last turning point of oscillation is configured to take place more than 35 seconds before the termination time of heating.

6. A method as claimed in claim 4, wherein a transfer travel out of the tempering furnace is first carried out by a lower speed and, subsequently, the lower speed is accelerated to a higher speed.

7. A method as claimed in claim 6, wherein the oscillation and the speeds of movement of the glass sheets are controlled such that during the heating, only two turning points of oscillation are provided, so that the first turning point of oscillation and the starting time of heating are spaced quite widely apart, and the last turning point of oscillation and the termination time of heating are spaced quite widely apart.

8. An apparatus for heating sheets of glass, the apparatus comprising a tempering furnace for heating glass sheets, rollers for carrying and transferring the glass sheets, heating means for heating the glass sheets, and a control device for controlling the rollers, the control device being configured to control the rollers such that the glass sheets are oscillated during the heating, wherein the control device is configured to control the rollers such that a first turning point of oscillation is configured to take place more than 20 seconds after a starting time of heating.

9. An apparatus as claimed in claim 8, wherein the control device is configured to control the rollers such that the first turning point of oscillation is configured to take place more than 35 seconds after the starting time of heating.

10. An apparatus as claimed in claim 8, wherein the control device is configured to control the rollers such that a transfer travel from a loading conveyor to the furnace is first carried out at a first speed and, subsequently, the speed is dropped to a second speed which is a lower speed than the first speed.

11. An apparatus as claimed in claim 10, wherein the control device is configured to control the rollers such that a last turning point of oscillation is configured to take place more than 20 seconds before a termination time of heating.

12. An apparatus as claimed in claim 11, wherein the control device is configured to control the rollers such that the last turning point of oscillation is configured to take place more than 35 seconds before the termination time of heating.

13. An apparatus as claimed in claim 11, wherein the control device is configured to control the rollers such that a transfer travel out of the tempering furnace is configured to be first carried out at a lower speed and, at a final stage of the transfer travel, at a higher speed.

14. An apparatus as claimed in claim 13, wherein the control device is configured to control the rollers such that heating is configured to be such that during the heating, only two turning points of oscillation take place, so that the first turning point of oscillation and the starting time of heating are spaced quite widely apart, and the last turning point of oscillation and the termination time of heating are spaced quite widely apart.
